(19) United States
(12) Patent Application Publication
(10) Pub. No.: US 2010/0215083 A1
(43) Pub. Date: Aug. 26, 2010

(54) Method for Allocating Rake Fingers in Multi-Carrier Systems

(76) Inventors: Elias Jonsson, Malmo (SE); Oskar Drugge, Lund (SE)

Correspondence Address: COATS & BENNETT, PLLC, 1400 Crescent Green, Suite 300, Cary, NC, 27518, US

(21) Appl. No.: 12/391,371

(22) Filed: Feb. 24, 2009

(51) Int. Cl. H04B 1/707

(52) U.S. Cl. 375/148; 375/E01.032

(57) ABSTRACT

A multi-carrier RAKE receiver is described herein. The multi-carrier RAKE receiver distributes RAKE fingers between a plurality of received carriers based on a comparison between the signal-to-interference ratios (SIRs) determined for each carrier. In one embodiment, the RAKE fingers are distributed evenly between the carriers when a comparison between the largest and smallest SIR is less than or equal to a threshold. In another embodiment, the RAKE fingers are distributed to favor the carrier(s) with the strongest SIR(s) when the comparison between the largest and smallest SIR exceeds the threshold. By distributing the RAKE fingers to favor the carriers with the strongest SIRs, the embodiments of the present invention enable the system designers to limit the total number of available RAKE fingers without sacrificing performance.

### BACKGROUND

The present invention relates generally to wireless receivers, and more particularly to finger allocation for multi-carrier receivers that receive multi-path signals.

Wireless signals often travel multiple propagation paths between a transmitter and an intended receiver. As a result, the intended receiver receives a composite signal that includes multiple images of a transmitted signal, where each image generally experiences different path delay, phase, and attenuation effects. Different signal images therefore arrive at the receiver at different times, causing a delay spread between the received signal images. The maximum delay spread between signal images depends on, among other things, the differing characteristics of the signal propagation paths.

Because the signal energy is distributed among the multiple signal images, wireless devices often use a RAKE or Generalized RAKE (G-RAKE) receiver that combines the received signal images to improve the signal-to-noise ratio (SNR) of the output signal. RAKE receivers include a plurality of RAKE fingers tuned to different delays to despread signal images. Typically, the RAKE receiver tunes its available RAKE fingers to the strongest signal images, such that each selected signal image is despread, weighted, and subsequently combined with the other selected and despread signal images. Combining multiple signal images in this manner generally improves the SNR of the received signal.

To improve wireless data rates, wireless communication systems may also use different frequency carriers for different users. To compensate for multi-path propagation issues associated with each carrier, receivers in such multi-carrier systems may include one RAKE receiver subsystem for each carrier, where each RAKE receiver subsystem includes one or more RAKE fingers. Ideally, each RAKE receiver subsystem includes enough fingers to despread each image of the received signal for the corresponding carrier. However, because receiver complexity increases as the number of RAKE fingers increases, the ideal RAKE finger distribution is not always possible.

### SUMMARY

Embodiments of the present invention provide methods and apparatuses in a multi-carrier RAKE receiver that distribute RAKE fingers between a plurality of received carriers based on a comparison between the signal-to-interference ratios (SIRs) determined for each carrier. In one embodiment, the RAKE fingers are distributed evenly between the carriers when a comparison between the largest and smallest SIR meets a first criteria, e.g., is less than or equal to a threshold. In another embodiment, the RAKE fingers are distributed to favor the carrier(s) with the strongest SIR(s) when the comparison between the largest and smallest SIR meets a second criteria, e.g., is greater than a threshold. By distributing the RAKE fingers to favor the carriers with the strongest SIRs, the embodiments of the present invention enable the system designers to limit the total number of available RAKE fingers without sacrificing performance. The embodiments may be realized in a wireless communication device comprising the multi-carrier RAKE receiver.

### BRIEF DESCRIPTION OF THE DRAWINGS

FIG. 1 shows a block diagram of an exemplary multi-carrier receiver according to one embodiment of the present invention.

FIG. 2 shows an exemplary method for distributing RAKE fingers between carriers according to one embodiment of the present invention.

FIG. 3 shows an exemplary method for distributing the RAKE fingers between carriers to favor the carrier(s) with the strongest SIR(s).

FIG. 4 shows a block diagram of an exemplary multi-carrier RAKE system for the receiver of FIG. 1.

### DETAILED DESCRIPTION

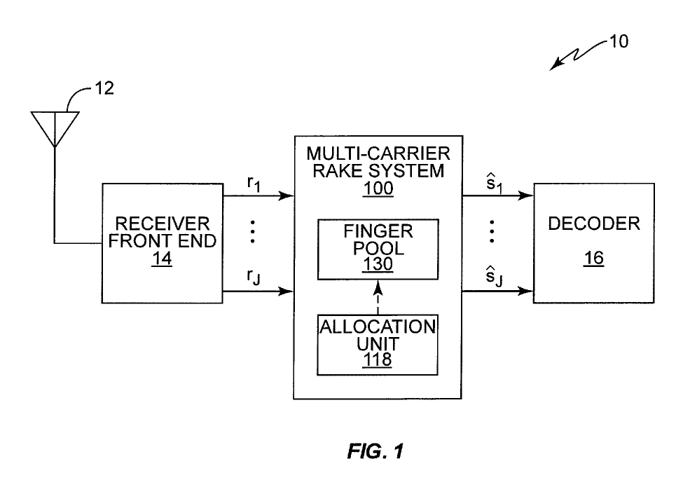

FIG. 1 shows a block diagram of a multi-carrier receiver 10 according to one embodiment of the present invention. Receiver 10 includes one or more antennas 12, receiver front-end 14, multi-carrier RAKE system 100, and decoder 16. Front-end 14 amplifies, filters, and downconverts the signal received by the antenna(s) 12 to generate a baseband signal rⱼ for each of the J carriers. Multi-carrier RAKE system 100 separately delays, despreads, weights, and combines the baseband signal images associated with different carriers to generate symbol estimates ŝⱼ for each carrier. Decoder 16 processes the symbol estimates output by the multi-carrier RAKE system 100 to recover the transmitted information bits for each carrier.

Typical multi-carrier RAKE receivers include a separate RAKE subsystem for each carrier, where each RAKE subsystem includes a fixed number of RAKE fingers for each carrier. When designed for a large number of carriers, the excessively large number of RAKE fingers required for such an arrangement makes the receiver prohibitively complex. Further, a fixed allocation is inefficient; there will be some circumstances where the RAKE subsystem for one carrier has more fingers than necessary, while the RAKE subsystem for another carrier does not have enough fingers.

The multi-carrier RAKE system 100 of embodiments of the present invention solves the problem associated with a fixed allocation by providing an allocation unit 118 that distributes RAKE fingers from a common RAKE finger pool 130 to the carriers. The allocation unit 118 determines the number of fingers to allocate to each carrier based on the channel conditions associated with each carrier. When the common pool of carriers 130 has enough fingers to give each carrier the desired number of fingers, the allocation unit 118 allocates the desired number of fingers to each carrier. However, when the common pool of carriers 130 does not include enough fingers to give each carrier the desired number of fingers, allocation unit 118 distributes the RAKE fingers between the carriers based on the channel conditions. For example, the allocation unit 118 may determine a signal-to-interference ratio (SIR) for each carrier, and distribute the RAKE fingers between the carriers based on a comparison between the SIRs, e.g., evenly if a difference between the SIRs is less than a threshold and according to a selected distribution process if the SIR difference exceeds the threshold.

To distribute the RAKE fingers between the carriers, the allocation unit 118 first determines Ñⱼ, the number of RAKE fingers desired by each of the j={1, 2, . . . ,J} carriers. The allocation unit 118 may compute the desired number of fingers for each carrier as a function of the delay spread associated each carrier. For example, the allocation unit 118 may determine the desired number of fingers Ñⱼ for the j^{th} carrier by dividing the maximum delay spread for the j^{th} carrier by a desired granularity, e.g., half chip, quarter chip, etc.

When the total number of desired fingers for the carriers does not exceed the total number of available RAKE fingers in the finger pool 130, e.g.,

$${\sum }_{j = 1}^{J} {\tilde{N}}_{j} \leq {N}_{total} ,$$

allocation unit 118 allocates the desired number of RAKE fingers to each carrier, e.g., Nⱼ=Ñⱼ. Because the total number of RAKE fingers in the finger pool 130 may be limited to reduce receiver complexity, the multi-carrier RAKE system 100 may not always have enough RAKE fingers to give each carrier the desired amount. When the total number of desired fingers for the carriers exceeds the total number of RAKE fingers in the finger pool 130, e.g.,

$${\sum }_{j = 1}^{J} {\tilde{N}}_{j} > {N}_{total} ,$$

the allocation unit 118 of embodiments of the present invention compares the signal-to-interference ratios (SIRⱼ) determined for the carriers, and distributes the RAKE fingers between the carriers based on the SIR comparisons.

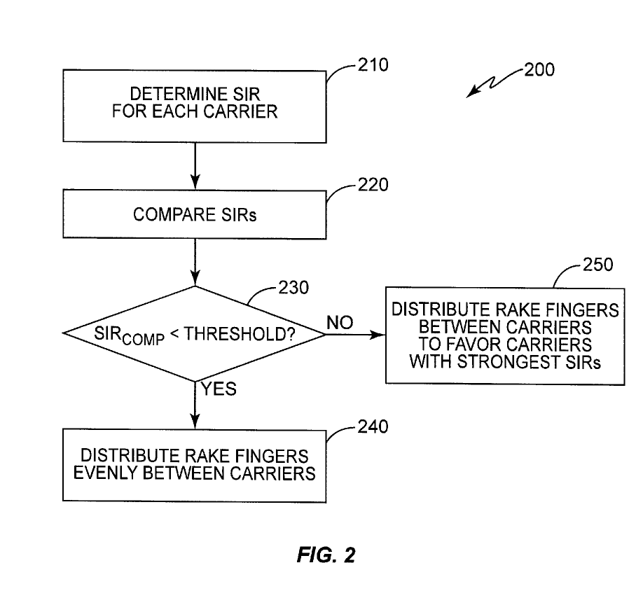

FIG. 2 shows one exemplary finger distribution process 200 executed by the allocation unit 118 when the total number of desired RAKE fingers exceeds the number of available RAKE fingers in the common finger pool 130. The finger distribution process 200 is based on signal-to-interference ratios determined for each carrier. It will be appreciated that the SIRs may include the effects of both noise and interference.

For simplicity, process 200 is described for a two-carrier system. The allocation unit 118 determines SIR₁ and SIR₂ for respective carrier input signals r₁ and r₂ (block 210). The allocation unit 118 then compares SIR₁ and SIR₂ to determine a comparison metric SIR_{comp} (block 220), and compares SIR_{comp} to a threshold, where the threshold is selected to generally indicate whether or not SIR₁ and SIR₂ differ by a small amount (block 230). For example, a threshold of 0.5 dB may be used to generally indicate whether or not SIR₁ and SIR₂ differ by more than 0.5 dB. If the comparison metric SIR_{comp} is less than or equal to the threshold (block 230), indicating that the difference between SIR₁ and SIR₂ is small, the allocation unit 118 distributes the RAKE fingers evenly between the carriers (block 240). However, if the comparison metric SIR_{comp} exceeds the threshold, indicating that the difference between SIR₁ and SIR₂ is large (block 230), the allocation unit 118 distributes the RAKE fingers between the carriers to favor the carrier with the strongest SIR (block 250).

It will be appreciated that embodiments of the present invention are not limited to the threshold criterion described herein for process 200; other criteria may be used. It will also be appreciated that a basic embodiment of process 200 may omit the even finger distribution option, and instead may always distribute the RAKE fingers to favor the carrier with the strongest SIR. Thus, blocks 230 and 240 in FIG. 2 are optional.

The following describes different methods for distributing the RAKE fingers between r₁ and r₂ to favor the carrier with the larger SIR when the total number of desired fingers for the carriers exceeds the total number of available RAKE fingers, e.g., Ñ₁+Ñ₂>Nₜₒₜₐₗ. In the following examples, it is assumed that the first carrier has the largest SIR. It will be appreciated that embodiments of the present invention are not limited to the specific finger distribution methods described herein.

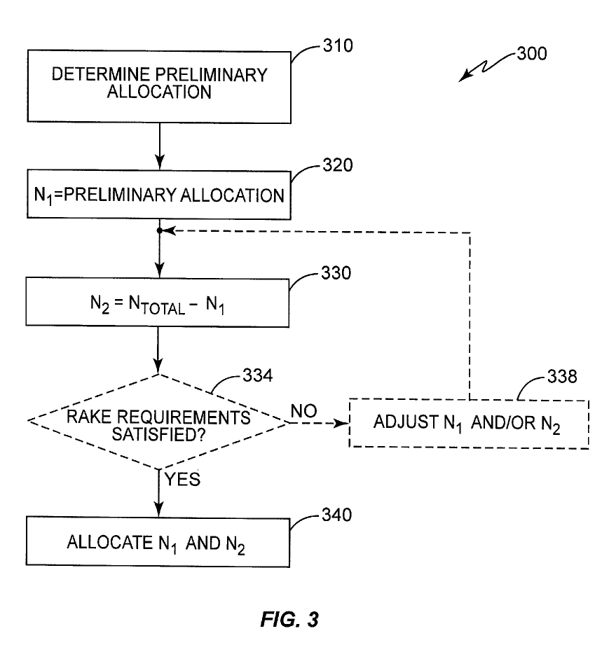

FIG. 3 shows one exemplary finger distribution method 300. Allocation unit 118 determines a preliminary allocation (block 310), and initially allocates fingers to the first carrier by setting N₁ equal to the preliminary allocation (block 320). For example, the allocation unit 118 may determine a preliminary allocation based on a relative comparison between Ñ₁ and a finger differential, e.g., the difference between the total number of available fingers Nₜₒₜₐₗ and the number of second carrier path delays |τ₂| (block 310). Subsequently, the allocation unit 118 initially allocates N₁=min(Ñₜₒₜₐₗ−|τ₂|) fingers to the first carrier (block 320). The allocation unit 118 then initially allocates the remaining fingers, e.g., N₂=Nₜₒₜₐₗ−N₁, to the second carrier (block 330).

In some embodiments, the allocation unit 118 uses the initial allocation as the final allocation (block 340). However, other optional embodiments may further consider one or more predefined RAKE requirements, e.g., a minimum finger allocation requirement, when distributing the RAKE fingers. As long as the finger distribution satisfies the predefined RAKE requirement(s) (block 334), the allocation unit 118 distributes the initially allocated N₁ fingers to the first carrier and the initially allocated N₂ fingers to the second carrier (block 340). However, if the initial finger allocations do not satisfy the predefined requirement(s), the allocation unit 118 adjusts the initial finger allocations for the first carrier and/or the second carrier until the predetermined requirements are satisfied (block 338). For example, if the RAKE system 100 requires each carrier to have at least two fingers, and the initial values for N₁ and/or N₂ allocate less than two fingers to each carrier, the allocation unit 118 may redistribute the RAKE fingers to meet the minimum finger requirement, e.g., redistribute some fingers from the first carrier to the second carrier. Additionally or alternatively, the allocation unit 118 may adjust N₁ and/or N₂ to ensure that the allocation unit 118 has a sufficient number of computational cycles to compute the RAKE combining weights for the allocated fingers, as discussed further below.

In another exemplary embodiment, the allocation unit 118 uses a finger scaling factor β₁ to enable external factors, e.g., delay spread, to control how the finger allocation favors the carrier with the higher SIR. The finger scaling factor β₁ is a value between 0.0 and 1.0 and may be fixed or periodically updated based on current channel or communication conditions, e.g., delay spread, Doppler frequency shift, etc. A scaling factor of 0.0 corresponds to granting a carrier 0% of the desired number of fingers, while a scaling factor of 1.0 corresponds to granting the carrier 100% of the desired number of fingers.

For the scaling embodiment, the preliminary allocation is determined based on a relative comparison between the total number of available fingers Nₜₒₜₐₗ and the scaled version of the desired number of fingers for the first carrier β₁Ñ₁ (block 310), wherein the allocation unit 118 initially allocates N₁=min(floor(β₁Ñ₁),Nₜₒₜₐₗ) fingers to the first carrier (block 320). Subsequently, allocation unit 118 initially allocates N₂=Nₜₒₜₐₗ−N₁ fingers to the second carrier (block 330). The allocation unit 118 then optionally considers any predefined RAKE receiver requirements before finally allocating N₁ RAKE fingers to the first carrier and updating the allocation of N₂=Nₜₒₜₐₗ−N₁ RAKE fingers to the second carrier (blocks 334, 338, 340).

In one exemplary embodiment, the allocation unit 118 sets β₁=1.0. This scaling factor guarantees that the carrier with the highest SIR will be granted as many fingers as possible regardless of any other RAKE system conditions.

In another embodiment, the scaling factor β₁ is periodically adjusted based on the delay spread. For this embodiment, the scaling factor β₁ is inversely proportional to the desired number of RAKE fingers, e.g., β₁∝(1/Ñ₁), where the desired number of fingers is determined based on the root mean square (RMS) delay spread. In this case, β₁ may be periodically adjusted such that the carriers associated with channels with a low delay spread can be granted a higher percentage of the desired number of fingers (e.g., 100%), while carriers associated with channels with a higher delay spread can be granted a lower percentage of the desired number of fingers (e.g., 80%).

In still another embodiment, the scaling factor β₁ may be periodically adjusted based on the Doppler frequency shift of the carriers. For example, the carrier experiencing a higher Doppler shift may be allocated slightly fewer fingers. This option accounts for the fact that RAKE receiver processing is generally less effective in the presence of high Doppler shifts, and therefore compensates for the problem that may arise when two mobile devices traveling at the same speed are associated with different carrier frequencies, and therefore have different Doppler shifts.

Another embodiment may determine a final finger scaling factor β₁ based on a combination of multiple different determination methods. For example, a final scaling factor β₁ may be determined based on an average of the finger scaling factors determined based on the delay spread and the Doppler frequency shift.

As mentioned above, when distributing the RAKE fingers, the allocation unit 118 may also consider the number of computational cycles required to determine RAKE combining weights for the allocated RAKE fingers. In general, the allocation unit 118 distributes the fingers so that the total number of computational cycles required for the allocated RAKE fingers does not exceed the maximum number of available computational cycles, e.g., cycles(N₁)+cycles(N₂)≦cyclesₘₐₓ, where cycles(Nⱼ) represents the number of computational cycles required to calculate Nⱼ combining weights for the Nⱼ fingers. If the total number of computational cycles exceeds the maximum number of available cycles, the allocation unit 118 may iteratively remove one finger from each carrier's allocation until the total number of required computational cycles does not exceed the maximum number of available computational cycles.

Alternatively, the allocation unit 118 may consider the computational cycles separately for each carrier when distributing the RAKE fingers. For example, the allocation unit 118 may allocate N₁ fingers to r₁, where N₁ is the maximum number of fingers satisfying both N₁≦min(Ñ₁,Nₜₒₜₐₗ−|τ₂|) and cycles(N₁)≦cyclesₘₐₓ−cycles(|τ₂|). Alternatively, the allocation unit 118 may allocate N₁ fingers to r₁, where N₁ is the maximum number of fingers satisfying both N₁≦min(floor(βÑ₁),Nₜₒₜₐₗ) and cycles(N₁)≦cyclesₘₐₓ. In either case, the allocation unit 118 may allocate N₂=Nₜₒₜₐₗ−N₁ RAKE fingers to r₂.

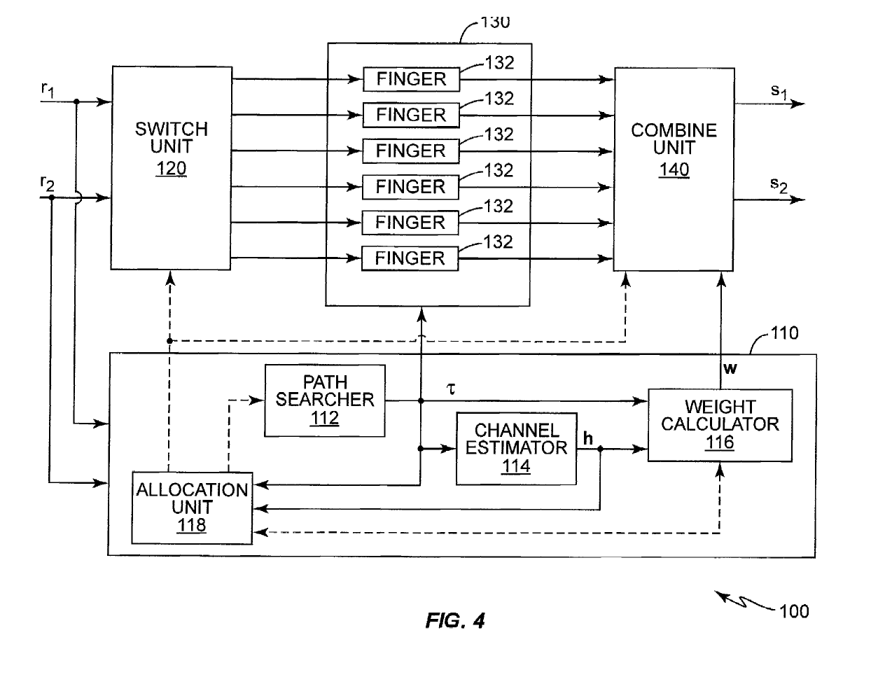

FIG. 4 shows an exemplary multi-carrier RAKE system 100 according to one embodiment of the present invention. Multi-carrier RAKE system 100 includes a RAKE processor 110, a switch unit 120, the finger pool 130 comprising a plurality of RAKE fingers 132, and a RAKE combine unit 140. While FIG. 4 only shows two carriers and six RAKE fingers, it will be appreciated that the multi-carrier system 100 may be used for any number of carriers and that the common finger pool 130 may include any number of RAKE fingers 132.

Processor 110 distributes the RAKE fingers 132 between the carriers, provides the corresponding path delays and combining weights for each carrier, and generates control signals for the switch unit 120 and combine unit 140 based on the determined finger distribution. Switch unit 120 selectively connects each of the baseband signals r₁ and r₂ to one or more RAKE fingers 132 responsive to the control signal. The RAKE fingers 132 delay and despread different images of the input signals {r₁,r₂}. The combine unit 140 weights and combines the despread signals output by the RAKE fingers 132 for each carrier to generate the symbol estimates ŝ₁ and ŝ₂ for each carrier.

The processor 110 includes a path searcher 112, channel estimator 114, weight calculator 116, and allocation unit 118. The path searcher 112 determines a set of path delays τⱼ for each of the carriers based on the input signals rⱼ, while the channel estimator 114 determines channel estimates hⱼ for the paths identified by the path searcher 112. The weight calculator 116 determines a set of combining weights wⱼ allocated to each carrier based on the path delays and channel estimates. The allocation unit 118 distributes the RAKE fingers 132 according to the processes discussed above. Once allocation unit 118 determines the finger distribution, the allocation unit 118 generates the corresponding control signal for the switch unit 120 and the combine unit 140. Further, the allocation unit 118 generates a control signal for the path searcher 112 and the weight calculator 116 to match the path delays and combining weights with the correct RAKE fingers 132.

The embodiments discussed above are described in terms of a two-carrier system. However, each embodiment may be extended to a multi-carrier system having more than two carriers. The extended multi-carrier solution of embodiments of the present invention assumes that the total number of desired fingers for all carriers exceeds the total number of available fingers, e.g.,

$${\sum }_{j = 1}^{J} {\tilde{N}}_{j} > {N}_{total} ,$$

and that SIR₁≧SIR₂≧ . . . ≧SIR_{J}. While not required, the following descriptions include the computational cycle requirement when distributing the fingers 132.

For the extended multi-carrier solution, the comparison metric SIR_{comp} is derived from the difference between the largest and smallest SIRs, e.g., SIR₁ and SIR_{J}, respectively. When none of the carriers have a dominant SIR, e.g., when SIR_{comp} is less than or equal to a threshold, the allocation unit 118 evenly distributes the RAKE fingers 132 between the carriers. For example, the allocation unit 118 may allocate

$${N}_{even} = min ( {\tilde{N}}_{j} , \frac{{N}_{total}}{J} )$$

fingers 132 to each carrier. When the allocation unit 118 also considers the number of computational cycles, the allocation unit 118 may further limit Nₑᵥₑₙ to the maximum number of fingers satisfying

$$cycles ( {N}_{even} ) \leq \frac{{cycles}_{max}}{J} .$$

When the comparison metric exceeds the threshold, e.g., when SIR₁>>SIR_{J}, the allocation unit 118 favors the carrier(s) with the stronger SIR(s). More particularly, the allocation unit 118 will, in this example, favor the first carrier over the second carrier, the second carrier over the third carrier, etc. For example, the allocation unit 118 may distribute the RAKE fingers 132 between the carriers based on the number of path delays for the different carriers. First, the allocation unit 118 determines the maximum number of RAKE fingers for the first carrier (N₁) that satisfy

$${N}_{1} \leq min ( {\tilde{N}}_{1} , {N}_{total} - {\sum }_{j = 2}^{J} \vert {τ}_{j} \vert ) ,$$

and optionally

$$cycles ( {N}_{1} ) \leq ( {cycles}_{max} - {\sum }_{j = 2}^{J} cycles ( \vert {τ}_{j} \vert ) ) .$$

Subsequently, the allocation unit 118 determines the maximum number of RAKE fingers 132 for the second carrier (N₂) that satisfy

$${N}_{2} \leq min ( {\tilde{N}}_{2} , {N}_{total} - {N}_{1} - {\sum }_{j = 3}^{J} \vert {τ}_{j} \vert ) ,$$

and optionally

$$cycles ( {N}_{2} ) \leq ( {cycles}_{max} - cycles ( {N}_{1} ) - {\sum }_{j = 3}^{J} cycles ( \vert {τ}_{j} \vert ) ) .$$

This process continues until the allocation unit 118 allocates the number of fingers for the carrier with the lowest SIR by determining the maximum value for N_{J} that satisfies

$${N}_{J} = min ( {\tilde{N}}_{J} , {N}_{total} - {\sum }_{j = 1}^{J - 1} {N}_{j} ) ,$$

and optionally

$$cycles ( {N}_{J} ) \leq ( {cycles}_{max} - {\sum }_{j = 1}^{J - 1} cycles ( {N}_{j} ) ) .$$

The scaling factor-based distribution embodiment discussed above may also be used for the extended multi-carrier solution. In this case, the allocation unit 118 may use a carrier-specific finger scaling factor to determine Nⱼ for each carrier. Each finger scaling factor βⱼ may be any value between 0.0 and 1.0, and may be determined according to any of the embodiments discussed above. First, the allocation unit 118 determines the maximum value for N₁ that satisfies N₁≦min(floor(β₁Ñ₁),Nₜₒₜₐₗ), and optionally cycles(N₁)≦cyclesₘₐₓ. Subsequently, the allocation unit 118 determines the maximum value for N₂ that satisfies N₂≦min(floor(β₂Ñ₁),Nₜₒₜₐₗ−N₁), and optionally cycles(N₂)≦(cyclesₘₐₓ−cycles(N₁)). This process continues until the allocation unit 118 allocates the number of fingers for the carrier with the lowest SIR by determining the maximum value for N_{J} that satisfies

$${N}_{J} \leq min ( f loor ( {β}_{J} {\tilde{N}}_{J} ) , {N}_{total} - {\sum }_{j = 1}^{J - 1} {N}_{j} ) ,$$

and optionally

$$cycles ( {N}_{J} ) \leq ( {cycles}_{max} - {\sum }_{j = 1}^{J - 1} cycles ( {N}_{j} ) ) .$$

The above describes how multi-carrier RAKE systems may distribute a common pool of RAKE fingers 132 between carriers, even when the multi-carrier RAKE system 100 limits the number of available RAKE fingers 132 to reduce the complexity of the RAKE system 100. Thus, embodiments of the present invention reduce the complexity associated with conventional multi-carrier RAKE systems without sacrificing performance.

Embodiments of the present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of allocating a plurality of RAKE fingers in a wireless multi-carrier receiver, the method comprising:
determining a signal-to-interference ratio for each received carrier; and
distributing the RAKE fingers between the carriers based on a comparison of the signal-to-interference ratios.

2. The method of claim 1 wherein distributing the RAKE fingers comprises:
comparing a first signal-to-interference ratio determined for a first carrier with a second signal-to-interference ratio determined for a second carrier to determine a comparison metric; and
distributing the RAKE fingers to favor the first carrier when the comparison metric meets a first criteria.

3. The method of claim 2 further comprising dividing the RAKE fingers equally between the first and second carriers when the comparison metric meets a second criteria.

4. The method of claim 3 wherein the first criteria corresponds to exceeding a threshold, and wherein the second criteria corresponds to being less than or equal to the threshold.

5. The method of claim 2 wherein distributing the RAKE fingers to favor the first carrier comprises:
determining a desired number of first fingers for the first carrier;
determining a preliminary allocation based on a total number of available RAKE fingers and the desired number of first fingers; and
allocating a first number of RAKE fingers to the first carrier based on the preliminary allocation.

6. The method of claim 5 further comprising determining how many computational cycles are required to compute RAKE combining weights for the first number of RAKE fingers, wherein allocating the first number of RAKE fingers to the first carrier comprises allocating the first number of RAKE fingers to the first carrier based on the preliminary allocation and the required number of computational cycles.

7. The method of claim 5 wherein distributing the RAKE fingers further comprises allocating the remaining RAKE fingers to the second carrier.

8. The method of claim 5 wherein determining the preliminary allocation comprises:
determining a finger differential between the total number of available RAKE fingers and a minimum number of delay peaks corresponding to the second carrier; and
setting the preliminary allocation equal to the smaller of the finger differential and the desired number of first fingers.

9. The method of claim 5 wherein determining the preliminary allocation comprises:
scaling the desired number of first fingers by a finger scaling factor, wherein the finger scaling factor comprises a number between 0.0 and 1.0;
setting a floor value equal to the largest integer less than or equal to the scaled desired number of first fingers; and
setting the preliminary allocation equal to the smaller of the total number of available RAKE fingers and the floor value.

10. The method of claim 9 wherein the finger scaling factor equals 1.0.

11. The method of claim 9 further comprising deriving the finger scaling factor from an inverse of the desired number of first fingers.

12. The method of claim 9 further comprising deriving the finger scaling factor based on a Doppler frequency shift associated with the first carrier.

13. The method of claim 9 further comprising:
deriving a first scaling factor from an inverse of the desired number of first fingers;
deriving a second scaling factor based on a Doppler frequency shift associated with the first carrier; and
determining the finger scaling factor based on a weighted average of the first and second scaling factors.

14. The method of claim 1 wherein distributing the RAKE fingers comprises:
comparing the largest signal-to-interference ratio to the smallest signal-to-interference ratio to determine a comparison metric;
distributing the RAKE fingers equally between the carriers when the comparison metric is less than or equal to a threshold; and
distributing the RAKE fingers to favor the carrier(s) with the strongest signal-to-interference ratio(s) when the comparison metric exceeds the threshold.

15. A multi-carrier receiver comprising:
a finger bank comprising a plurality of RAKE fingers;
a processor configured to:
determine a signal-to-interference ratio for each received carrier;
compare the signal-to-interference ratios; and
distribute the RAKE fingers between the carriers based on the signal-to-interference ratio comparisons.

16. The multi-carrier receiver of claim 15 wherein the processor is configured to compare the signal-to-interference ratios by comparing a first signal-to-interference ratio determined for a first carrier with a second signal-to-interference ratio determined for a second carrier to determine a comparison metric, and wherein the processor is configured to distribute the RAKE fingers by distributing the RAKE fingers to favor the first carrier when the comparison metric meets a first criteria.

17. The multi-carrier receiver of claim 16 wherein the processor is configured to distribute the RAKE fingers by dividing the RAKE fingers equally between the first and second carriers when the comparison metric meets a second criteria.

18. The multi-carrier receiver of claim 17 wherein the first criteria corresponds to exceeding a threshold, and wherein the second criteria corresponds to being less than or equal to the threshold.

19. The multi-carrier receiver of claim 16 wherein the processor is configured to distribute the RAKE fingers to favor the first carrier by:
determining a desired number of first fingers for the first carrier;
determining a preliminary allocation based on a total number of available RAKE fingers and the desired number of first fingers; and
allocating a first number of RAKE fingers to the first carrier based on the preliminary allocation.

20. The multi-carrier receiver of claim 19 wherein the processor is further configured to determine how many computational cycles are required to compute RAKE combining weights for the first number of RAKE fingers, and wherein the processor is configured to allocate the first number of RAKE fingers to the first carrier based on the preliminary allocation and the required number of computational cycles.

21. The multi-carrier receiver of claim 19 wherein the processor is configured to allocate the remaining RAKE fingers to the second carrier.

22. The multi-carrier receiver of claim 19 wherein the processor is configured to determine the preliminary allocation by:
determining a finger differential between the total number of available RAKE fingers and a minimum number of delay peaks corresponding to the second carrier; and
setting the preliminary allocation equal to the smaller of the finger differential and the desired number of first fingers.

23. The multi-carrier receiver of claim 19 wherein the processor is configured to determine the preliminary allocation by:
scaling the desired number of first fingers by a finger scaling factor, wherein the finger scaling factor comprises a number between 0.0 and 1.0;
setting a floor value equal to the largest integer less than or equal to the scaled desired number of first fingers; and
setting the preliminary allocation equal to the smaller of the total number of available RAKE fingers and the floor value.

24. The multi-carrier receiver of claim 23 wherein the finger scaling factor equals 1.0.

25. The multi-carrier receiver of claim 23 wherein the processor is further configured to derive the finger scaling factor from an inverse of the desired number of first fingers.

26. The multi-carrier receiver of claim 23 wherein the processor is further configured to derive the finger scaling factor based on a Doppler frequency shift associated with the first carrier.

27. The multi-carrier receiver of claim 23 wherein the processor is further configured to derive the finger scaling factor by:
deriving a first scaling factor from an inverse of the desired number of first fingers;
deriving a second scaling factor based on a Doppler frequency shift associated with the first carrier; and
determining the finger scaling factor based on a weighted average of the first and second scaling factors.

28. The multi-carrier receiver of claim 15 wherein the processor is configured to distribute the RAKE fingers by:
comparing the largest signal-to-interference ratio to the smallest signal-to-interference ratio to determine a comparison metric;
distributing the RAKE fingers equally between the carriers when the comparison metric is less than or equal to a threshold; and
distributing the RAKE fingers to favor the carrier(s) with the strongest signal-to-interference ratio(s) when the comparison metric exceeds the threshold.

29. The multi-carrier receiver of claim 15, wherein the processor is further configured to generate a distribution control signal based on the RAKE finger distribution; and wherein the multi-carrier receiver further comprises
a switch unit configured to connect the RAKE fingers in the finger bank and input signals associated with the different carriers responsive to the control signal; and
a combine unit comprising a plurality of combiners, where each combiner is configured to RAKE combine the RAKE finger outputs responsive to the control signal.

30. The multi-carrier receiver of claim 15 wherein the multi-carrier receiver is disposed in a wireless communication device.
